(19) United States
(12) Patent Application Publication
(10) Pub. No.: US 2026/0147183 A1
(43) Pub. Date: May 28, 2026

(54) OPTICAL IMAGING LENS AND OPTICAL PLASTIC LENS ASSEMBLY THEREOF

(71) Applicant: Genius Electronic Optical (Xiamen) Co., Ltd., Xiamen (CN)

(72) Inventors: CHI-SHENG FANG, Taichung City (TW); YUE-LIN YANG, Taichung City (TW); FENG CHEN, Xiamen (CN)

(73) Assignee: Genius Electronic Optical (Xiamen) Co., Ltd., Xiamen (CN)

(21) Appl. No.: 19/398,365

(22) Filed: Nov. 24, 2025

(30) Foreign Application Priority Data
Nov. 25, 2024 (CN) 2024116974375

(51) Int. Cl. G02B 13/00; G02B 1/04; G02B 1/115; G02B 7/02

(52) U.S. Cl. CPC G02B 13/001; G02B 1/041; G02B 1/115; G02B 7/021; G02B 7/025

(57) ABSTRACT

An optical imaging lens and an optical plastic lens assembly are provided by the present invention. The optical plastic lens assembly comprises a first plastic lens element and a second plastic lens element, positioned from an object side to an image side. Each of the first and second plastic lens elements comprises an optical portion and a mounting portion, formed in a radial direction, from center to edge. The mounting portion comprises an object-side supporting surface facing the object side and an image-side supporting surface facing the image side. At least one first coevaporate and at least one second coevaporate are positioned between the image-side supporting surface of the first plastic lens element and object-side supporting surface of the second plastic lens element. The first coevaporate at least comprises aluminum and zirconium. The second coevaporate at least comprises phosphorus, oxygen, and at least one metal element of cerium, tungsten, iron, gallium and bismuth.

### TECHNICAL FIELD

The present invention relates to an optical imaging lens and an optical plastic lens assembly thereof, in particular to an optical imaging lens and an optical plastic lens assembly thereof comprising plural plastic lens elements.

### BACKGROUND

Due to the increasing complexity of modern optical components, the increase in the number of lenses on electronic devices, and the upgrading of zoom functions, volume utilization and miniaturization have become increasingly important. The removal or reduction of the base or mount fixers used to fix the lens elements in the optical lens needs to be considered when the volume utilization is increased. Then, the lens element needs to be self-supporting by a means of adhesion, in order to maintain the fixation and integrity of the optical structure of the lens as a whole. In general, the lens element can be bonded by a means of gluing, and the gel used is mostly a polymer curing substance. Although such polymer curing substance can achieve the bonding and supporting effect, but it is easy to cause indeterminate changes in lens pitch and parallelism, and these uncertainties will affect the performance of the lens, for example, the lens modulation transfer function (MTF), and the flare, and so on.

### SUMMARY

The present invention provides an optical imaging lens and an optical plastic lens assembly thereof. The optical imaging lens can be used for taking images and recordings, such as mobile phones, cameras, tablet PCs, car cameras, Personal Digital Assistants (PDAs), and Augmented Reality (AR) or Virtual Reality (VR) wearable devices. In the optical plastic lens assembly, the first and second plastic lens elements are bonded to each other through the mechanism of the active surface formed by the activated first and second coevaporate layers configured between the first and second plastic lens elements.

The optical plastic lens assembly provided according to an embodiment of the present invention comprises a first plastic lens element and a second plastic lens element, and the first plastic lens element and the second plastic lens element both comprise an optical portion and an mounting portion that are formed from the inside out in a radial direction. The assembly portion comprises an object-side supporting surface facing an object side and an image-side supporting surface facing an image side. At least one first coevaporate and at least one second coevaporate are positioned between the image-side supporting surface of the first plastic lens element and object-side supporting surface of the second plastic lens element. The first coevaporate at least comprises aluminum and zirconium. The second coevaporate at least comprises phosphorus, oxygen, and at least one metal element of cerium, tungsten, iron, gallium and bismuth.

The optical plastic lens assembly according to another embodiment of the present invention comprises a first plastic lens element and a light shield. The first plastic lens element comprises an optical portion formed from the inside out in a radial direction and a mounting portion comprises an object-side supporting surface facing an object side and an image-side supporting surface facing an image side. The light shield comprises an object-side surface facing the object side and an image-side surface facing the image side. At least one first coevaporate and at least one second coevaporate are disposed between the image-side supporting surface of the first plastic lens element and the object-side surface of the light shield. The first coevaporate comprises at least aluminum and zirconium, and the second coevaporate comprises at least phosphorus, oxygen, and at least one of the metallic elements of cerium, tungsten, iron, gallium, and bismuth.

An optical imaging lens according to a further embodiment of the present invention comprises any of the optical plastic lens element assemblies according to the present invention.

### BRIEF DESCRIPTION OF THE DRAWINGS

Exemplary embodiments will be more readily understood from the following detailed description when read in conjunction with the appended drawing, in which:

FIG. 1 illustrates a schematic structure of a first plastic lens element of a first embodiment of the present invention;

FIG. 2 shows a schematic diagram of the cross-section structure of the optical plastic lens assembly in which the first plastic lens element and the second plastic lens element are bonded in the first embodiment of the present invention;

FIG. 3 illustrates the cross-section structure of the optical plastic lens assembly of the first embodiment of the present invention shown in FIG. 2, corresponding to the portion of the AA′ line segment during a manufacturing process;

FIG. 4 illustrates a cross-sectional structural view of the AA′ line segment portion of the optical plastic lens assembly of the first embodiment of the present invention shown in FIG. 2 of the present invention;

FIG. 5 illustrates a cross-section of one of the partial structures of the optical plastic lens assembly of the second embodiment of the present invention during a manufacturing process;

FIG. 6 illustrates a sectional structure of a partial structure of the optical plastic lens assembly of the second embodiment of the present invention shown in FIG. 5;

FIG. 7 illustrates a schematic structure of a light shield of the third embodiment of the present invention;

FIG. 8 illustrates a schematic diagram of the sectional structure of a light shield of the third embodiment of the present invention shown in FIG. 7;

FIG. 9 illustrates a schematic diagram of the cross-section structure of an optical plastic lens assembly of the third embodiment of the present invention;

FIG. 10 illustrates the elemental analysis results of the first plastic lens element of the first embodiment of the present invention after forming the first coevaporate;

FIG. 11 illustrates the elemental analysis results of the first plastic lens element of the first embodiment of the present invention after forming the second coevaporate;

FIG. 12 illustrates a schematic diagram of the cross-sectional structure of the optical imaging lens of the fourth embodiment of the present invention.

### DETAILED DESCRIPTION

For a more complete understanding of the present disclosure and its advantages, reference is now made to the following description taken in conjunction with the accompanying drawings, in which like reference numbers indicate like features. Persons of ordinary skill in the art having the benefit of the present disclosure will understand other variations for implementing embodiments within the scope of the present disclosure, including those specific examples described herein. The drawings are not limited to specific scale and similar reference numbers are used for representing similar elements. As used in the disclosures and the appended claims, the terms “example embodiment,” “exemplary embodiment,” and “present embodiment” do not necessarily refer to a single embodiment, although it may, and various example embodiments may be readily combined and interchanged, without departing from the scope or spirit of the present disclosure. Furthermore, the terminology as used herein is for the purpose of describing example embodiments only and is not intended to be a limitation of the disclosure. In this respect, as used herein, the term “in” may include “in” and “on”, and the terms “a”, “an” and “the” may include singular and plural references. Furthermore, as used herein, the term “by” may also mean “from”, depending on the context. Furthermore, as used herein, the term “if” may also mean “when” or “upon”, depending on the context. Furthermore, as used herein, the words “and/or” may refer to and encompass any and all possible combinations of one or more of the associated listed items.

An object side and an image side revealed in this specification are the corresponding directions for the predefined assembly of the optical plastic lens assembly or optical imaging lens, and have their own definitions in optics. Usually, the object side is the side where the object is located, and the image side is the side where the image is located. The optical imaging lens disclosed here comprises several plastic lens elements, such as the first plastic lens element and the second plastic lens element, along an optical axis from the object side to the image side to receive the imaging rays entering the optical imaging lens which is parallel to the optical axis to within a half-field-of-view (HFOV) angle with respect to the optical axis. The imaging rays passing through the optical imaging lens are imaged on an image plane. There is no limit to the number and shape of the plastic lens elements, and each plastic lens element has two surfaces facing the object side and the image side respectively, and an optical portion and a mounting portion are formed from the inside out in a radial direction. The optical portion includes an object-side surface facing the object side and an image-side surface facing the image side, and the mounting section includes an object-side supporting surface facing the object side and an image-side supporting surface facing the image side. The optical axis is a virtual line that ideally passes through the center of curvature of the object-side and image-side surfaces of each plastic lens element. The radial direction is the direction of the radius of the optical portion on the surface of the plastic lens element. The term “optical portion of the plastic lens element” is defined as the portion corresponding to the imaging rays that passes through a specific area of the surface of the plastic lens element. Imaging rays include at least two types of rays: chief rays and marginal rays. The term “mounting portion of the plastic lens element” is defined as the corresponding portion of the surface of the plastic lens element that extends outwardly from an optical boundary of the surface of the plastic lens element in the radial direction, roughly the corresponding portion of the plastic lens element other than the optical portion of the plastic lens element to which the imaging rays do not reach. The mounting portion is generally used for the plastic lens element to be assembled to one of the corresponding components of the optical imaging lens, which is described in more detail below. The term “optical boundary of the surface of the plastic lens element” is defined as the point at which the outermost marginal ray in the radial direction passing through the surface of the plastic lens element intersects the surface of the plastic lens element. In particular embodiments, the plastic lens element may comprise a blackening treatment area, which has been subjected to at least one of the following blackening treatments: inking, laminating, and blackening, which in turn facilitates the avoidance of stray light. The structure and shape of the optical portion are merely illustrative of the invention and do not limit the scope of the invention. The optical imaging lens of the present invention comprises an optical plastic lens assembly, through which the first and second coevaporates configured between the first and second plastic lens elements are activated to form an active surface to achieve a mechanism for the first and second plastic lens elements to bond with each other, and a number of embodiments are provided below.

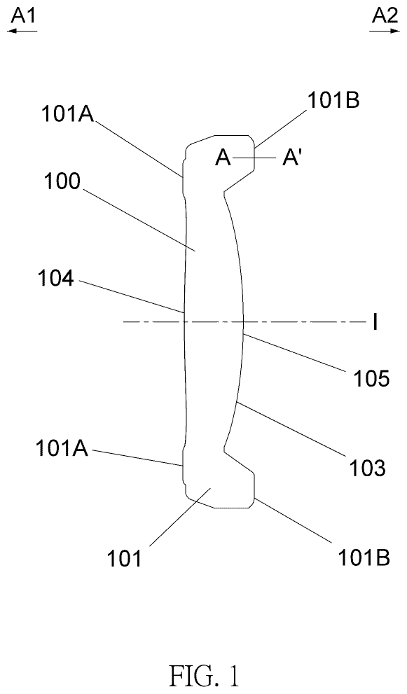

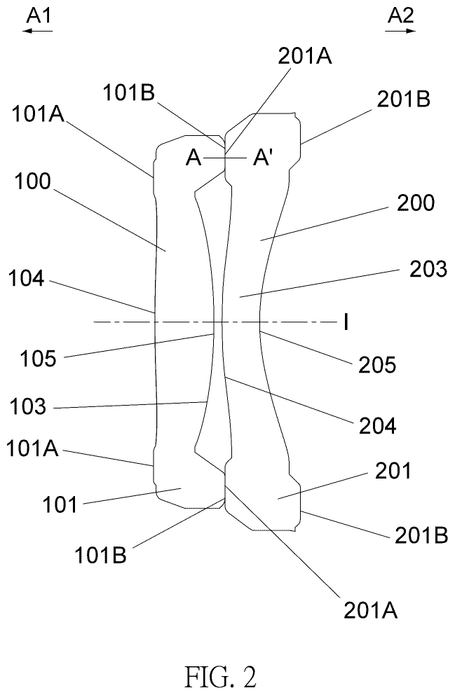

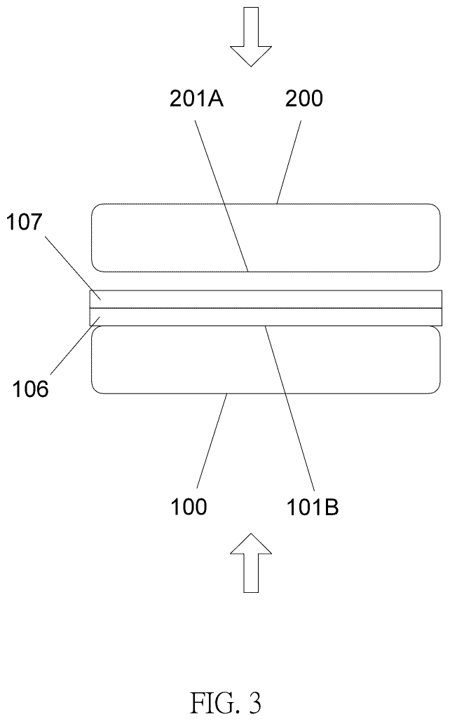

First, please refer to FIGS. 1 and 2 together, wherein FIG. 1 illustrates the structure of the first plastic lens element of the first embodiment of the present invention, and FIG. 2 illustrates the cross-sectional structure of the optical plastic lens assembly in which the first plastic lens element and the second plastic lens element of the first embodiment of the present invention are bonded. The first plastic lens element 100 comprises an optical portion 103 and a mounting portion 101 formed from the inside out in the radial direction. The optical section 103 comprises an object-side surface 104 towards an object side A1 and an image-side surface 105 towards an image side A2, and the mounting portion 101 comprising an object-side supporting surface 101A towards the object side A1 and an image-side supporting surface 101B towards the image side A2. An optical axis I is a virtual line passing through the center of curvature of the object-side surface 104 and the image-side surface 105 of the optical portion 103. In this example, the first plastic lens element 100 has a first coevaporate 106 and a second coevaporate 107 (both shown in FIG. 3) formed on the image-side supporting surface 101B, with the first coevaporate 106 including at least aluminum and zirconium, and the second coevaporate 107 including at least phosphorus, oxygen, and at least one of the metallic elements of cerium, tungsten, iron, gallium, and bismuth. In detail, the compound of the vapor-deposited material of the second coevaporate 107 is at least one of a group consisting of a compound of a lanthanum element, a tungsten compound, an iron compound, a indium compound, a gallium compound, and a bismuth compound, preferably at least one of a group consisting of a compound of a cycium oxide, a cycium fluoride compound, a tungsten compound such as tungsten oxide, an iron compound, a gallium compound, and a bismuth compound, more preferably at least one of a group consisting of a cycium oxide and a cycium fluoride compound, a gallium compound, and a bismuth compound, and most preferably one of cerium oxide and the cerium fluoride. The first coevaporate 106 and/or the second coevaporate 107 may additionally comprise other elements or sublayers.

In accordance with the foregoing, it is understood that the first coevaporate 106 and the second coevaporate 107 are not polymer gels. It is herein possible to pre-activate the surfaces between the plastic lens elements, comprising at least one or more layers of coating on one of the surfaces, whose layer structure comprises at least the first coevaporate 106 and the second coevaporate 107, by vacuum ultraviolet or deep-ultraviolet light (Vacuum ultraviolet VUV or Deep-ultraviolet DUV, hereinafter referred to as UV), so as to create an adhesive force for bonding the plastic lens elements. Such bonding surface may be at least one of the object-side supporting surface 101A and/or the image-side supporting surface 101B of the first plastic lens element 100, wherein the image-side supporting surface 101B is taken as an example, and thus the image-side supporting surface 101B is used with another plastic lens element, herein referred to as the second plastic lens element 200, to form the optical plastic lens assembly shown in FIG. 2, but not limited thereto. In other embodiments, the object-side supporting surface of the first plastic lens element may also be covered with a first coevaporate and a second coevaporate as a bonding surface, the first coevaporate and the second coevaporate being closer to the object-side supporting surface, and being activated to produce adhesion for bonding the second plastic lens element. In another embodiment, both the object-side supporting surface and the image-side supporting surface of the first plastic lens element can be used as the bonding surface. In this embodiment, as shown in FIG. 2, the second plastic lens element 200, similar to the first plastic lens element 100, includes an optical portion 203 having an object-side surface 204 and an image-side surface 205, and an mounting portion 201 having an object-side supporting surface 201A and an image-side supporting surface 201B, with the optical portion 203 including the object-side surface 204 and the image-side surface 205. The vacuum ultraviolet light and the deep ultraviolet light are herein exemplified as electromagnetic wave radiation in the wavelength range of 10 nm to 200 nm.

In detail, the aforementioned first coevaporate 106 is preferably a zirconium-aluminum oxide coevaporate (ZrO₂/Al₂O₃), which is used to enhance the adhesion of the second coevaporate 107 to the first plastic lens element 100. The first coevaporate 106 has a preferred thickness of 10 nm to 20 nm, and is characterized by the chemical formula AlᵤZrᵥO_{(2x+1.5u)}, in which u is the atomic percentage (at. %) of aluminum measured by SEM/EDX method, and v is the atomic percentage of zirconium measured by SEM/EDX method. The u/v in the formula is preferably in the range of 17 to 47 to achieve a better ratio of Al to Zr. The second coevaporate 107 is preferably a hydrophilic hydroxyapatite (Hydroxyapatite, Ca₁₀(PO₄)₆(OH)₂) and cerium oxide (CeO₂) to produce an active surface. The second coevaporate 107 has a preferred thickness of 50-60 nm and is characterized by the chemical formula Ca_{w-x}Ceₓ(PO₄), (OH)_{y/3}, in which x is the atomic percentage of cerium measured by SEM/EDX method, w is the sum of the atomic percentage of calcium measured by SEM/EDX method and the atomic percentage of cerium measured by SEM/EDX method, (w−x) is the atomic percentage of calcium measured by SEM/EDX method, and y is the atomic percentage of phosphorus measured by the SEM/EDX method. In the chemical formula, x/(w−x) is preferably in the range of 8.24 to 9.49, so that a better proportional relationship between Ce and Ca can be presented, and w/y is the ratio of (Ca+Ce)/P and is preferably in the range of 2.43 to 2.64, so that a better proportional relationship between Ce and Ca can be presented. The first coevaporate 106 and the second coevaporate 107 form a bilayer structure of the coevaporate, hereinafter referred to as co-evaporated bilayers. When the second coevaporate 107 is formed on the outermost surface of the first coevaporate 106, it is possible to effectively form the active surface after UV irradiation by virtue of its ability to form a hydroxyl-rich hydrophilic surface for bonding with the second plastic lens element 200. In this case, the bonding is due to physical and chemical forces including chemical bonding, mechanical locking bonding, and van der Waals force. This bonding, because it does not use an actual external gel, produces a minimized mechanical structure change, and at the same time reduces the impact on the MTF, glare, and other performance.

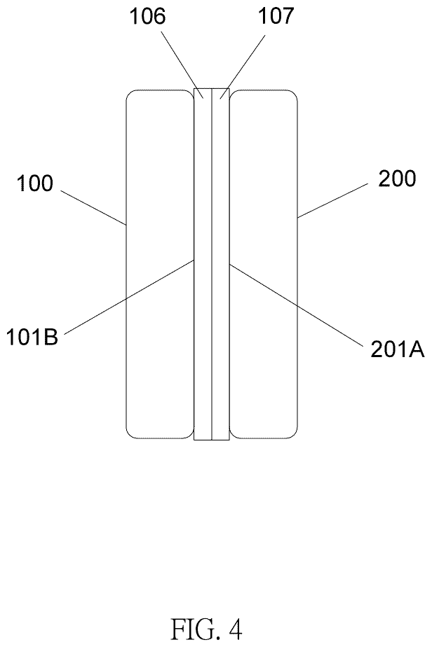

The UV activation and bonding process used in the present embodiment is described as follows: First, the surface of the first plastic lens element 100 to be activated, assumed to be the image-side supporting surface 101B, and the surface of the second plastic lens element 200 to be bonded, such as the object-side supporting surface 201A, are cleaned with argon-oxygen-nitrogen RF plasma treatment, in which an oxygen and nitrogen ratio in the gas environment of argon (Ar)-oxygen (O₂)-nitrogen (N₂) is 0˜25% Molar ratio, the total pressure is maintained at 70 m Torr, the plasma power is 600 W, and the treatment time is 35 seconds. Next, the UV lighting equipment was adjusted to a gas environment of pure air, nitrogen or argon gas, in which the surface was irradiated with UV at an energy intensity of 65 mW/cm², the light source is 3 mm away from the surface, and the irradiation time is 39 seconds. The surface was activated after irradiation. As shown in FIG. 3 corresponding to the line segment AA′ of FIG. 2, the activated surface is then contacted with the surface to be bonded of the second plastic lens element 200, e.g., the object-side supporting surface 201A, within an hour after activation, and then put in an oven with a fixture applying a pressure of 1.49 to 4.5 N/mm² to be baked at a temperature of 120° C. for an hour. The inside of the oven is filled with air. After baking, the surface of the first plastic lens element 100 and the surface of the second plastic lens element 200 can be stably bonded as shown in FIG. 4. Please note that because the first plastic lens element 100 and the second plastic lens element 200 are placed upside down on the fixture during the baking process, the coordinates shown in FIG. 3 are 90 degrees different from those in FIG. 2.

Note that upon activation of the surface to be activated of the first plastic lens element 100 by UV light, the M-H chemical bonding on the surface is broken, where M may be C, N, or O, and the solid end forms a polymer bond-breaking radical and a hydrogen atom radical. Secondly, molecules originally present on the surface, such as water or oxygen molecules, are broken down or reacted to hydroxyl radicals, oxygen atom (O(1D)) and ozone (O₃), which are unstable molecules, and can lead to oxidative cross-linking or the formation of hydroxyl-rich molecules (Hydroxyl, Carboxyl group) surface. When such surfaces are brought into contact with each other and heated under pressure, a condensation reaction may occur that bonds some parts of the two surfaces together by covalent bonding, while the other areas may be mechanically locked or van der Waals bonded.

It should be noted that the position and number of the first coevaporate 106 and the second coevaporate 107 are not limited herein, as long as there is at least one first coevaporate 106 and at least one second coevaporate 107 between the surfaces to be bonded of the first plastic lens element 100 and the second plastic lens element 200. The position and number of such surfaces may also be varied in accordance with the actual needs. For example, in other embodiments, the surface may be the object-side supporting surface of the first plastic lens element, in which case the first coevaporate and the second coevaporate may also be formed on the object-side supporting surface of the first plastic lens element, or the surface may be the object-side supporting surface and the image-side supporting surface of the first plastic lens element, in which case the first coevaporate and the second coevaporate may be formed on both the object-side supporting surface and the image-side supporting surface of the first plastic lens element, the image-side supporting surface can be bonded to another plastic lens element, and the object-side supporting surface can be bonded to yet another plastic lens element.

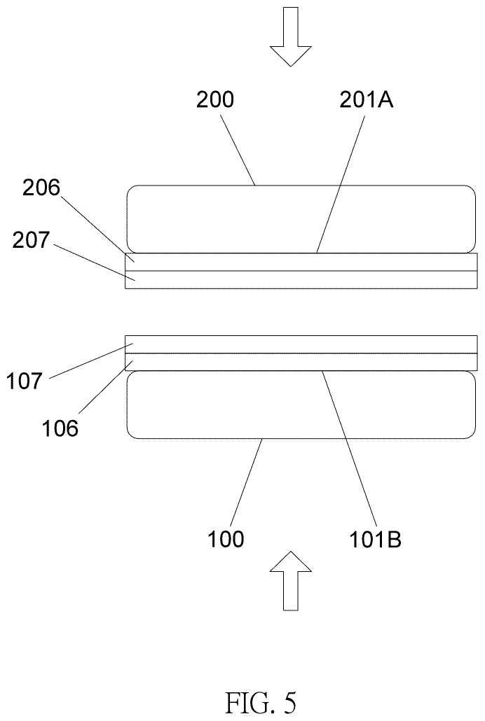

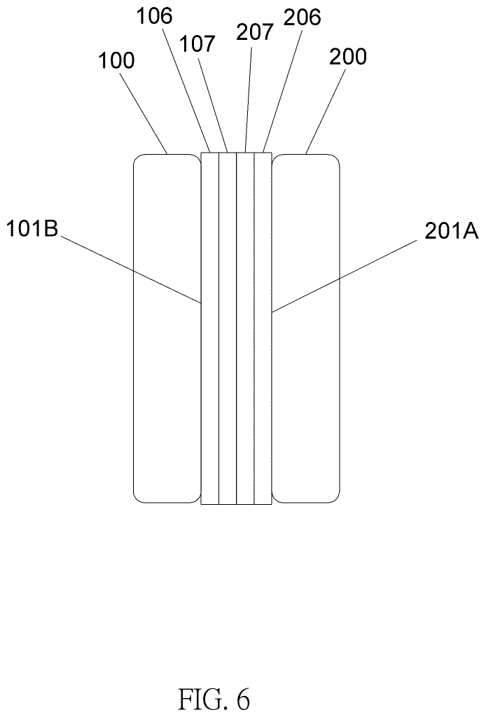

Preferably, in another embodiment, the bonding surface of the second plastic lens element may also be formed with another first coevaporate and another second coevaporate and activated to form another active surface, so that the two surfaces to be bonded, for example, the image-side supporting surface of the first plastic lens element and the object-side supporting surface of the second plastic lens element, are formed with the first coevaporate and the second coevaporate and activated to form active surfaces to provide stronger adhesion. The first coevaporate and the second coevaporate are formed and activated active surfaces to provide stronger adhesion. As shown in the second embodiment in FIGS. 5 and 6, based on the structure and configuration of the lens element of the optical plastic lens assembly of FIG. 2 but showing the portion corresponding to AA′ line segment of FIG. 2 only, the bonding surface of the second plastic lens element 200 to be bonded, such as the object-side supporting surface 201A, can also be formed with another first coevaporate 206 and another second coevaporate 207. The present embodiment utilizes the same UV activation and bonding process as the first embodiment and will not be repeated herein. After baking, the surface of the first plastic lens element 100 and the surface of the second plastic lens element 200 can be stably bonded as shown in FIG. 6. At this time, the other first coevaporate 206 can be in direct contact with the image-side supporting surface 101B of the first plastic lens element 100.

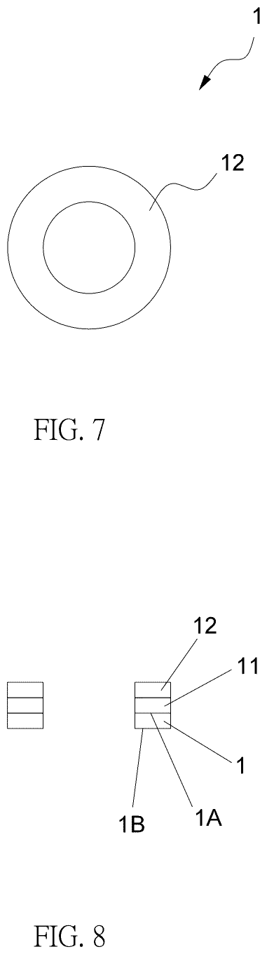

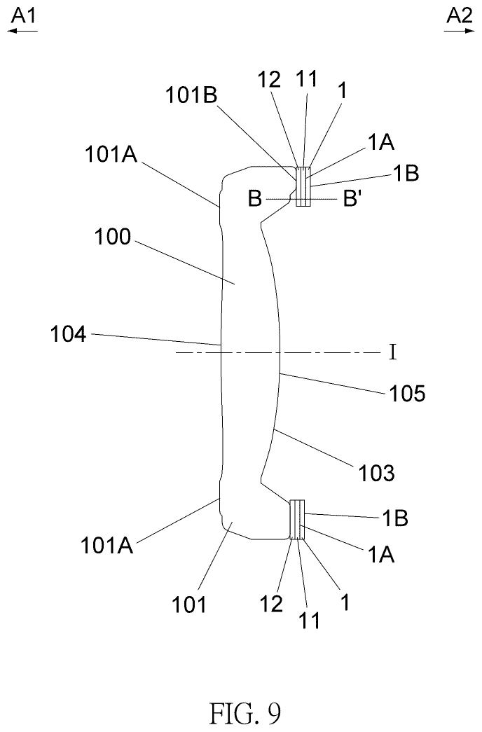

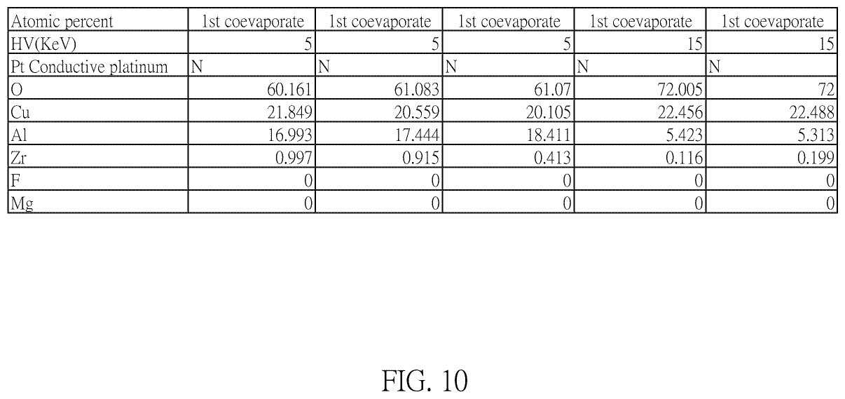

Please refer to FIGS. 7 to 9, wherein FIG. 7 illustrates a schematic structure of a light shield of the third embodiments of the present invention, FIG. 8 illustrates a schematic cross-sectional structure of the light shield of the third embodiments of the present invention, shown in FIG. 7, and FIG. 9 illustrates a schematic structure of a cross-section of an optical plastic lens assembly in the third embodiment of the present invention. In the present embodiment, the first coevaporate and the second coevaporate are applied to bond the first plastic lens element and a light shield. For the sake of simplicity, the first plastic lens element 100 of the first embodiment is used herein as an example, and the differences between the present embodiment and the first embodiment are only illustrated, but the present embodiment is not limited thereto. As shown in FIGS. 7 and 9, the light shield 1 comprises an object-side surface 1A facing the object side A1 and an image-side surface 1B facing the image side A2, and provides an area (not shown in the drawings) for shielding light according to one of the requirement definitions. Assuming herein that the image-side supporting surface 101B of the first plastic lens element 100 is to meant to be bonded to the object-side surface 1A of the light shield 1, at least one first coevaporate 11 and at least one second coevaporate 12 are provided between the image-side supporting surface 101B of the first plastic lens element 100 and the object-side surface 1A of the light shield 1. The first coevaporate 11 comprises at least aluminum and zirconium and the second coevaporate 12 comprises at least phosphorus, oxygen, and at least one metallic element of cerium, tungsten, iron, gallium and bismuth. The first coevaporate 11 and/or the second coevaporate 12 may additionally include other elements or sublayers. In the present embodiment, a first coevaporate 11 and a second coevaporate 12 are successively formed on the object-side surface 1A of the light shield 1 using the same materials and processes as in the first embodiment, with the same characteristics and parameters, but the present embodiment is not limited to this. The position and number of the first coevaporate 11 and the second coevaporate 12 can be varied according to the actual needs. Additional film layers may be formed between, before, or after the first coevaporate 11 and the second coevaporate 12, such as: a light shield adhesive film (not shown) which may comprise TiO₂, etc. may be placed between the light shield 1 and the first coevaporate 11 in order to increase the adhesive force between the light shield 1 and the first coevaporate 11. The present embodiment adopts the same UV activation and bonding process as the first embodiment and will not be repeated herein. After baking, the surface of the first plastic lens element 100 and the surface of the light shield 1 can be stably bonded as shown in FIG. 9.

In other embodiments, at least one of the following variations may be made according to actual needs, such as: the object-side surface of the light shield is in direct contact with another first coevaporate which is in direct contact with the image-side supporting surface of the first plastic lens element; an anti-reflective film is formed and placed between the first coevaporate and the first plastic lens element.

On the other hand, in other embodiments, the optical plastic lens assembly may additionally be formed with an anti-reflective film (AR), which may be covered on any surface of any of the plastic lens elements or light shield, such as between the first coevaporate and the first plastic lens element, or between the first coevaporate and the second plastic lens element, which will be advantageous for reducing the stray light generated by the reflection of the plastic lens elements. The anti-reflective film includes any of SiO₂, TiO₂, MgF₂, Al₂O₃, MgAl₂O₄, Nb₂O₅, HfO₂, Ta₂O₅, ZrO₂, and so on. For example, the aforementioned co-evaporated bilayers may be formed directly on the AR, and the co-evaporated bilayers may be activated by UV to produce the active surface for bonding another plastic lens element, or the AR and the co-evaporated bilayers may be formed on the bonding surfaces of the first and the second plastic lens elements respectively, which are to be bonded. Taking the first plastic lens element 100 of the first embodiment as an example, which may be made of materials of APEL (Cyclo olefin copolymer) or EP (Polycarbonate) series, at least one of the surfaces of the first plastic lens element 100 for bonding, such as the image-side supporting surface 101B, is coated with co-evaporated bilayers. Prior to the formation of the co-evaporated bilayers, the AR formed by stacking a high refractive material (H) and/or a low refractive material (L) is additionally formed. The AR of the example herein is film layers of titanium dioxide and silicon dioxide stacked alternately, with the titanium dioxide in the AR closest to the surface of the first plastic lens element 100 or the second plastic lens element 200, which is advantageous for maintaining the adhesion between the first plastic lens element 100 and the second plastic lens element 200, or even for increasing the adhesion between the first plastic lens element 100 and the second plastic lens element 200. In detail, the AR of the example is an 8-layer film of titanium dioxide and silicon dioxide stacked alternately, wherein H represents the titanium dioxide (TiO₂) film layer and L represents the silicon dioxide (SiO₂) film layer, wherein the material of the first coevaporate closest to the surface of the first plastic lens element is H, and the last layer, as the H as the first layer, is L. After cleaning the surfaces of the first plastic lens element 100 with plasma, the first plastic lens element 100 and/or the second plastic lens element 200 or the light shield 1 of the third embodiment with a co-evaporated bilayers is UV-activated, and then the first plastic lens element 100 and the second plastic lens element 200 or the light shield 1 are clamped and baked to be bonded.

In other embodiments, the anti-reflective film may additionally include a second AR positioned between the first AR stacked with titanium dioxide and silicon dioxide and the first coevaporate. The second AR includes magnesium and fluorine, e.g., a MgF₂ film, which may be helpful in placing the two ARs on the first plastic lens element to minimize the chance of reflecting stray light and at the same time, allow the first plastic lens element bonding to an optical element. The anti-reflective film allows the first plastic lens element to be bonded to the optical element. Note that the structures and materials of the ARs, the first AR, and the second AR herein may be applied to any of the optical plastic lens assembly and optical imaging lenses of the present invention without limitation to the present embodiment.

The process and parameters for the preparation of the co-evaporated bilayers, as well as the experimental data for composition analysis and tensile strength testing are provided below.
(1) Here, ten samples of the first plastic lens element 100 are prepared, including Samples 1 and 2: no film layer formed on two supporting surfaces S1 and S2, Samples 3 and 4: co-evaporated bilayers formed on a supporting surface S1 and no film layer formed on the other supporting surface S2, Samples 5 and 6: co-evaporated bilayers formed on both supporting surfaces S1 and S2, Samples 7 and 8: an AR and co-evaporated bilayers formed on one supporting surface S1 in sequence but no film layer formed on the other supporting surface S2, and Samples 9 and 10: AR, MgF₂ film and co-evaporated bilayers formed on a single supporting surface S1 in sequence but no film layer formed on the other supporting surface S2. Here, the supporting surfaces S1 and S2 correspond to the image-side supporting surface 101B of the first plastic lens element 100 and the object-side supporting surface of the second plastic lens element, respectively.
(2) The chemical formulae of the selected materials are as follows: Hydroxyapatite is Cas (OH) (PO₄) 3, Cerium oxide is CeO₂, the first coevaporate is AlᵤZrᵥO_{(2x+1.5u)}, the second coevaporate is Ca_{w-x}Ceₓ(PO₄)_{y}(OH)_{y/3}, in which u/v is between 17˜47, w/y is (Ca+Ce)/P proportion and in the range of 2.43˜2.64, and x/(w−x) is in the range of 8.24˜9.49.
(3) Evaporation process to form the co-evaporated bilayers: Using a vacuum evaporation device (dome chamber diameter Φ1500 mm, evaporation distance 1500 mm), a sample of the first plastic lens element 100 of APEL (cycloolefin copolymer) or EP (polycarbonate) (diameter 4 mm, thickness 0.2 mm) was set in the dome chamber, and the co-evaporated bilayers evaporation material was set in the evaporation device. The pressure in the reaction chamber was reduced to less than 1.4×10⁻³ Pa, and the evaporation material (Canon PHILICFINE HP series material) was processed by electron gun pretreatment, i.e. irradiated with an electron beam with the baffle closed to be melted. The parameters of the electron gun pretreatment process are oxygen at 50 sccm, ion beam voltage 200 V, current 300 mA, and accelerating voltage 250 Vacc for 15 sec. Next, an electron beam with an accelerating voltage of 6 kV is injected into the melted evaporation material, and an evaporation film is formed by accumulating the vaporized components for co-evaporated bilayers on the sample. The evaporation chamber is fed with 50 sccm of oxygen gas, and pressure when forming the evaporation film is 1.4×10⁻² Pa. After the coating is completed, the vacuum device is restored to atmospheric pressure, and the sample is removed. The following table shows the evaporation materials and evaporation conditions for co-evaporated bilayers.

TABLE 1

| | | Acceleration | | | |
|---|---|---|---|---|---|
| | Melting | voltage of | Electron | | |
| Evaporation | time | electron gun | gun current | Inlet gas | Pressure |
| material | (sec) | (kV) | (mA) | (sccm) | (Pa) |
| First coevaporate: | 90 | 6 | 500 | Oxygen: 50 | 1.4*10⁻³ |
| Al_{(2) O3} + ZrO₂ | | | | | |
| Second | 45 | 6 | 200 | Oxygen: 50 | 1.4*10⁻³ |
| coevaporate: | | | | | |
| Ca_{(5) (}PO₄₎₃OH + | | | | | |
| CeO₂ | | | | | |

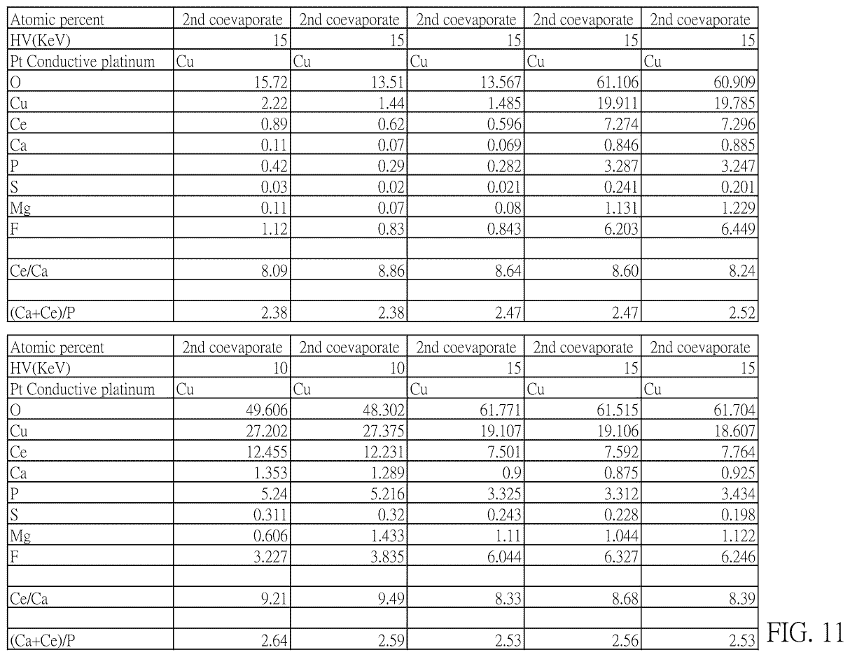

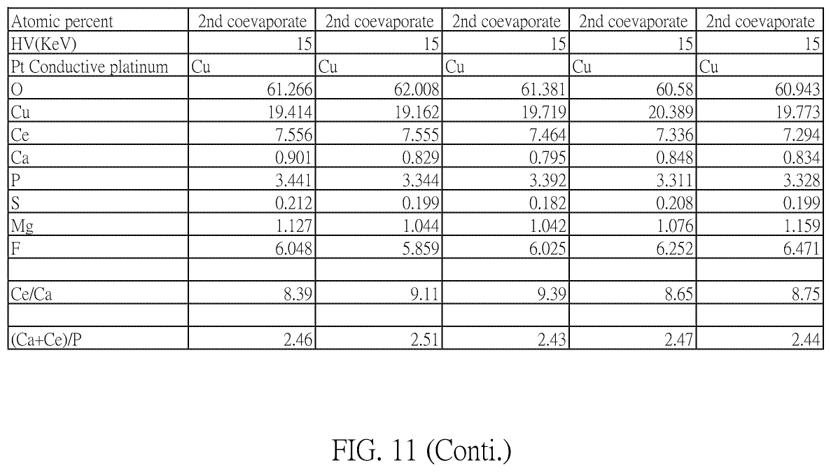

(4) The first plastic lens element 100 and the second plastic lens element are clamped and baked by the aforementioned clamping and baking process, and the baking time is one hour.
(5) Method of analyzing the composition of the co-evaporated bilayers: The sample of the first plastic lens element 100 after evaporation of the co-evaporated bilayers and activated by ultraviolet light was selected as an example to analyze the composition of the area without powder contamination on the surface by scanning electron microscope energy scattering X-ray spectroscopy (SEM/EDX). Here, five areas of the first coevaporate were selected for composition analysis, and the results are shown in FIG. 10. Fifteen areas of the second coevaporate were selected for composition analysis, and the results are shown in FIG. 11. The analyzing equipment used was a Regulus Field Emission Electron Microscope (FESEM) from HITACHI and a QUANTAX Energy Dispersive XFlash (EDX) detector from BRUKER. The analysis parameters are shown in Table 2. Signal analysis was performed using BRUKER's ESPRIT 2.3 analysis software database program to characterize the elemental species, and the quantitative method was performed using the P/B-ZAF model with a 20 nm Cu-film calibration model.

TABLE 2

| | | SEM Acceleration | X-ray fluorescence |
|---|---|---|---|
| | | Voltage | spectra of |
| Layer | Elements | (kV) | EDX analysis |
| First | Al | 5/15 | Kα |
| coevaporate | Zr | 5/15 | Lα |
| Second | Ca | 10/15 | Kα |
| coevaporate | Ce | 10/15 | Lα |
| | P | 10/15 | Kα |

(5) Tensile Test: Perform the following steps in sequence: (a) Attach a double-sided adhesive for tensile testing (3M KPU-12 ultra-strong double-sided adhesive test; tape) to the upper and lower fixtures of the tensile (b) Position the bonded first plastic lens 100 and second plastic lens element in an upside-down orientation and attach them to the lower fixture, where the first plastic lens 100 is the upper lens element and the second plastic lens is the lower lens element; (c) When the upper fixture is empty, press the “ZERO” button of the tensioner to zero; (d) Slowly lower the upper fixture so that the first plastic lens element 100 and the second plastic lens element after attached are adhered to the double-sided adhesive of the upper fixture, and give a certain amount of loading so that the first plastic lens element 100 and the second plastic lens element are completely adhered to the double-sided adhesive under a certain amount of pressure; (e) Press the “STOP” button of the tensioner and then the green up button to pull the lens elements apart at a constant speed of 6.5 mm/min until the tension data is obtained. Table 3 below reveals the experimental data of the adhesive force performance of combination 1˜10 after tensile strength test.

TABLE 3

| | | | Baking | | |
|---|---|---|---|---|---|
| | | | temperature | | Separation |
| Sample | | | after | Resting | pressure |
| No. | Side | Film stack | clamping | time | (N/mm²) |
| 1 | S1 | NA | 120° C. | 0 H (hours) | 1.24 |
| | S2 | NA | | | |
| 2 | S1 | NA | 120° C. | 96 H | 0.45 |
| | S2 | NA | | | |
| 3 | S1 | co-evaporated bilayers | 120° C. | 0 H | 0.95 |
| | S2 | NA | | | |
| 4 | S1 | co-evaporated bilayers | 120° C. | 96 H | 0.95 |
| | S2 | NA | | | |
| 5 | S1 | co-evaporated bilayers | 120° C. | 0 H | 0.9 |
| | S2 | co-evaporated bilayers | | | |
| 6 | S1 | co-evaporated bilayers | 120° C. | 96 H | 2.03 |
| | S2 | co-evaporated bilayers | | | |
| 7 | S1 | AR\co-evaporated bilayers | 120° C. | 0 H | 1.31 |
| | S2 | NA | | | |
| 8 | S1 | AR\co-evaporated bilayers | 120° C. | 96 H | 3.08 |
| | S2 | NA | | | |
| 9 | S1 | AR\MgF₂\co-evaporated | 120° C. | 0 H | 0.77 |
| | | bilayers | | | |
| | S2 | NA | | | |
| 10 | S1 | AR\MgF₂\co-evaporated | 120° C. | 96 H | 1.80 |
| | | bilayers | | | |
| | S2 | NA | | | |

The NA in Table 3 represents the absence of coating, the film stack is closer to the air as it goes to the right side, the resting environment is static in the air, and the separation pressure is the pressure required to separate the lens elements.

From the aforementioned experimental data, it can be learned that: (1) the aforementioned first coevaporate is favorable to increase the adhesion between the first plastic lens element 100 and the second coevaporate. By placing the first coevaporate and the second coevaporate between the first plastic lens element 100 and the bonding surface of the second plastic lens element to be bonded, it is advantageous for the second coevaporate to effectively form an active surface after being irradiated with UV radiation to bond with the bonding surface of the second plastic lens element. Preferably, the bonding surface of the second plastic lens element also includes the second coevaporate activated by UV. From the aforementioned experimental data, it can be seen that the separation pressure required to separate the two bonding surfaces does not decrease as the bonding time is increased to 96 hours; (2) when the first coevaporate is in direct contact with the bonding surface of the first plastic lens element 100 and the optical plastic lens assembly includes another first coevaporate in direct contact with the bonding surface of the second plastic lens element to be bonded, it will be advantageous to increase the separation pressure required for the two bonding surfaces as the bonding time is increased to 96 hours.

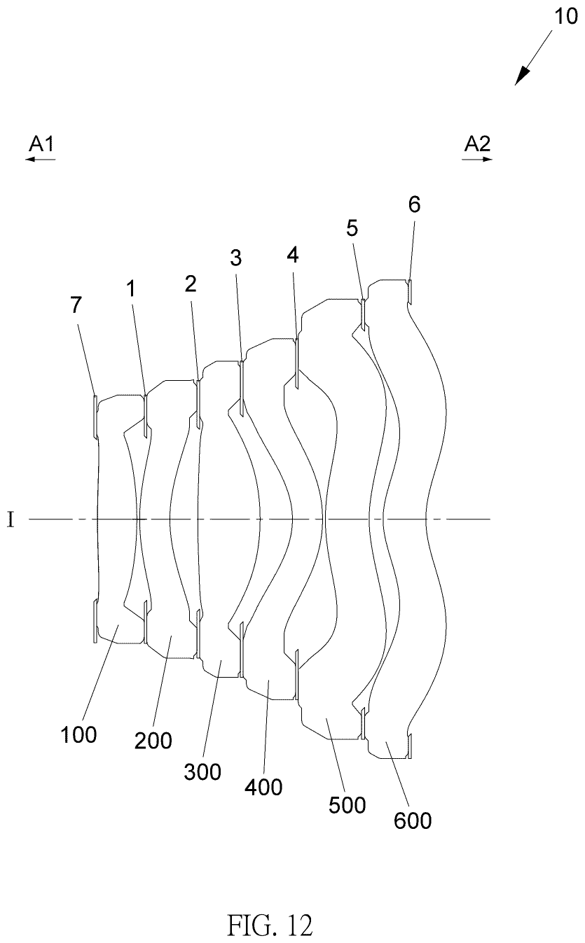

Please refer to FIG. 12, which illustrates the cross-sectional structure of the optical imaging lens of the fourth embodiment of the present invention. In this embodiment, the optical imaging lens 10 applies the optical plastic lens assembly of the third embodiment shown in FIG. 9 above, and the first plastic lens element 100 and the light shield 1 are assembled by bonding the first plastic lens element 100 and the light shield 1, and the same first coevaporate 11 and the second coevaporate 12 are further formed on the image-side surface 1B of the light shield 1 in order to bond to the object-side supporting surface of the second plastic lens element 200. In addition, the optical imaging lens 10 also applies a plurality of light shields 2, 3, 4, 5, each of which is formed with the first coevaporate 11 and the second coevaporate 12 on both the object-side supporting surface and the image-side supporting surface, so as to bond to and assemble the second plastic lens element 200, the third plastic lens element 300, the fourth plastic lens element 400, the fifth plastic lens element 500 and the sixth plastic lens element 600, thereby achieving a high volume utilization rate. The optical imaging lens 10 further comprises light shields 6 and 7, which are attached to the image-side supporting surface of the sixth plastic lens element 600 and the object-side supporting surface of the first plastic lens element 100, respectively, in order to provide a complete light-shielding effect. The first coevaporate and the second coevaporate are optionally formed on the object-side supporting surface and/or the image-side supporting surface of each of the first plastic lens element 100, the second plastic lens element 200, the third plastic lens element 300, the fourth plastic lens element 400, the fifth plastic lens element 500 and the sixth plastic lens element 600.

The contents in the embodiments of the invention include but are not limited to a focal length, a thickness of a lens element, an Abbe number, or other optical parameters. For example, in the embodiments of the invention, an optical parameter A and an optical parameter B are disclosed, wherein the ranges of the optical parameters, comparative relation between the optical parameters, and the range of a conditional expression covered by a plurality of embodiments are specifically explained as follows:
(1) The ranges of the optical parameters are, for example, α₂≤A≤α₁ or β₂≤B≤β₁, where α₁ is a maximum value of the optical parameter A among the plurality of embodiments, α₂ is a minimum value of the optical parameter A among the plurality of embodiments, β₁ is a maximum value of the optical parameter B among the plurality of embodiments, and β₂ is a minimum value of the optical parameter B among the plurality of embodiments.
(2) The comparative relation between the optical parameters is that A is greater than B or A is less than B, for example.
(3) The range of a conditional expression covered by a plurality of embodiments is in detail a combination relation or proportional relation obtained by a possible operation of a plurality of optical parameters in each same embodiment. The relation is defined as E, and E is, for example, A+B or A−B or A/B or A*B or (A*B)^{1/2}, and E satisfies a conditional expression E≤γ₁ or E≥γ₂ or γ₂≤E≤γ₁, where each of γ₁ and γ₂ is a value obtained by an operation of the optical parameter A and the optical parameter B in a same embodiment, γ₁ is a maximum value among the plurality of the embodiments, and γ₂ is a minimum value among the plurality of the embodiments.

The ranges of the aforementioned optical parameters, the aforementioned comparative relations between the optical parameters, and a maximum value, a minimum value, and the numerical range between the maximum value and the minimum value of the aforementioned conditional expressions are all implementable and all belong to the scope disclosed by the invention. The aforementioned description is for exemplary explanation, but the invention is not limited thereto.

In view of unpredictable nature of an optical imaging lens, based on the present invention, when an optical imaging lens meets at least one aforesaid inequality, its the lens elements may have be better assembled, positioned, protected and shaded to improve MTF of the optical imaging lens, reduce flare, or raise assembly yield, etc. to solve the problem of conventional systems.

Additionally, the section headings herein are provided for consistency with the suggestions under 37 C.F.R. § 1.77 or otherwise to provide organizational cues. These headings shall not limit or characterize the invention(s) set out in any claims that may issue from this disclosure. Specifically, a description of a technology in the “Background” is not to be construed as an admission that technology is prior art to any invention(s) in this disclosure. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings herein.

What is claimed is:

1. An optical plastic lens assembly, comprising a first plastic lens element and a second plastic lens element along an optical axis from an object side to an image side, each of the first plastic lens element and the second plastic lens element comprising an optical portion formed from the inside out in a radial direction and an mounting portion comprising an object-side supporting surface facing the object side and an image-side supporting surface facing the image side, and at least one first coevaporate and at least one second coevaporate being formed between the image-side supporting surface of the first plastic lens element and the object-side supporting surface of the second plastic lens element, the at least one first coevaporate comprising at least aluminum and zirconium, and the at least one second coevaporate comprising at least phosphorus, oxygen, and at least one metallic element among cerium, tungsten, iron, gallium, and bismuth.

2. The optical plastic lens assembly according to claim 1, further comprising another first coevaporate in direct contact with the object-side supporting surface of the second plastic lens element, and the first coevaporate in direct contact with the image side supporting surface of the first plastic lens element.

3. The optical plastic lens assembly according to claim 1, further comprising an anti-reflective film positioned between the first coevaporate and the first plastic lens element, or between the first coevaporate and the second plastic lens element.

4. The optical plastic lens assembly according to claim 3, wherein the anti-reflective film comprises a first anti-reflective film comprising titanium dioxide and silicon dioxide stacked alternately, and the first anti-reflective film closest to a surface of the first plastic lens element or the second plastic lens element is titanium dioxide.

5. The optical plastic lens assembly according to claim 4, wherein the anti-reflective film comprises a second anti-reflective film disposed between the first anti-reflective film and the first coevaporate, and the second anti-reflective film comprises magnesium and fluorine.

6. The optical plastic lens assembly according to claim 1, wherein the first plastic lens element and the second plastic lens element comprise a blackening treatment area that is subjected to at least one of the following blackening treatments: inking, laminating, and blackening.

7. The optical plastic lens assembly according to claim 1, wherein the first coevaporate satisfies 17≤u/v≤47, in which u is the atomic percentage (at. %) of aluminum measured by SEM/EDX method and v is the atomic percentage of zirconium measured by SEM/EDX method.

8. The optical plastic lens assembly according to claim 1, wherein the second coevaporate comprises cerium and calcium and satisfies 8.24≤x/(w−x)≤9.49, in which x is the atomic percentage of cerium measured by the SEM/EDX method, w is the sum of the atomic percentage of calcium measured by the SEM/EDX method and the atomic percentage of cerium measured by the SEM/EDX method, and (w−x) is the atomic percentage of calcium measured by the SEM/EDX method.

9. The optical plastic lens assembly according to claim 8, wherein the second coevaporate comprises cerium and satisfies 2.43≤w/y≤2.64, in which y is the atomic percentage of phosphorus measured by the SEM/EDX method.

10. An optical plastic lens assembly, comprising a first plastic lens element and a light shield along an optical axis from an object side to an image side, the first plastic lens element comprising an optical portion formed from the inside out in a radial direction and a mounting portion comprising an object-side supporting surface facing the object side and an image-side supporting surface facing the image side, the light shield comprising an object-side surface facing the object side and an image-side surface facing the image side, and at least one first coevaporate and at least one second coevaporate being disposed between the image-side supporting surface of the first plastic lens element and the object-side surface of the light shield, the first coevaporate comprising at least aluminum and zirconium, and the second coevaporate comprising at least phosphorus, oxygen, and at least one metallic element of cerium, tungsten, iron, gallium, and bismuth.

11. The optical plastic lens assembly according to claim 10, further comprising another first coevaporate in direct contact with the object-side surface of the light shield and the image-side supporting surface of the first plastic lens element.

12. The optical plastic lens assembly according to claim 10, further comprising an anti-reflective film positioned between the first coevaporate and the first plastic lens element.

13. The optical plastic lens assembly according to claim 12, wherein the anti-reflective film comprises a first anti-reflective film comprising titanium dioxide and silicon dioxide stacked alternately, and the first anti-reflective film closest to a surface of the first plastic lens element or the light shield is titanium dioxide.

14. The optical plastic lens assembly according to claim 10, wherein the anti-reflective film comprises a second anti-reflective film being disposed between the first anti-reflective film and the first coevaporate, the second anti-reflective film comprises magnesium and fluorine.

15. The optical plastic lens assembly according to claim 10, wherein the first plastic lens element and the light shield comprise a blackening treatment area that is subjected to at least one of the following blackening treatments: inking, laminating, and blackening.

16. The optical plastic lens assembly according to claim 10, wherein the first coevaporate satisfies 90≤u/v≤112, in which u is the atomic percentage of aluminum measured by SEM/EDX method and v is the atomic percentage of zirconium measured by SEM/EDX method.

17. The optical plastic lens assembly according to claim 10, wherein the second coevaporate comprises cerium and calcium and satisfies 8.24≤x/(w−x)≤9.49, in which x is the percentage of atoms of cerium measured by the SEM/EDX method, w is the sum of the percentage of atoms of calcium measured by the SEM/EDX method and the percentage of atoms of cerium measured by the SEM/EDX method, and (w−x) is the percentage of atoms of calcium measured by the SEM/EDX method.

18. The optical plastic lens assembly according to claim 10, wherein the second coevaporate comprises cerium and satisfies 2.43≤w/y≤2.64, in which y is the atomic percentage of phosphorus measured by SEM/EDX method.

19. The optical plastic lens assembly according to claim 10, wherein the optical plastic lens assembly comprises a light shield adhesive film disposed between the light shield and the first coevaporate.
